(19) United States
(12) Patent Application Publication
(10) Pub. No.: US 2005/0157325 A1
(43) Pub. Date: Jul. 21, 2005

(54) Apparatus having error self-diagnostics of a printing system and a method thereof

(76) Inventors: Jun-young Choi, Suwon-shi (KR); Young-dal Oh, Suwon-si (KR)

Correspondence Address: STANZIONE & KIM, LLP, 1740 N STREET, N.W., FIRST FLOOR, WASHINGTON, DC, 20036, US

(21) Appl. No.: 11/000,066

(22) Filed: Dec. 1, 2004

(30) Foreign Application Priority Data
Jan. 16, 2004 (KR) 2004-3446

(51) Int. Cl. G06F 15/00; G06F 11/00; G06F 3/12

(52) U.S. Cl. 358/1.14; 358/1.15; 714/48

(57) ABSTRACT

An apparatus having error self-diagnostics of a printing system capable of self-diagnosing a print error occurring from a host. The apparatus having error self-diagnostics includes an error database (DB) that stores a list of print errors that can occur from the host and a corresponding cause of error list, an error sensor that senses a print error occurrence, and a self-diagnostor that detects the error cause list corresponding to the sensed print error from the error DB and performs a correction process based on the cause of error list. Thus, it is possible to self-diagnose an error occurring from the host.

### CROSS-REFERENCE TO RELATED APPLICATIONS

This application claims benefit under 35 U.S.C. § 119 from Korean Patent Application No. 2004-3446, filed on Jan. 16, 2004, the entire content of which is incorporated herein by reference.

### BACKGROUND OF THE INVENTION

1. Field of the Invention

The present general inventive concept relates generally to an apparatus having error self-diagnostics of a printing system and a method thereof. More particularly, the present general inventive concept pertains to an apparatus having self-diagnostics of a printing system and a method thereof, in which a printing error occurring from a host of a printer is subjected to self-diagnostics performance and to error correction processing to transfer the corrected print error to the printer so that there is no need for the user's operation due to the printing error.

2. Description of the Related Art

In general, the printing system includes a printer for receiving print data and performing the print operations according to the print conditions set, and a host for translating documents prepared by application programs into print data that can be interpreted by the printer and transferring the print data to the printer.

If a document prepared by the application programs of the host is printed through the printer, the host must be installed with the printer driver program for driving the printer. The printer driver translates the document prepared by the application programs of the host into the language that can be interpreted by the printer.

FIG. 1 is a flowchart illustrating an example of an operating method of the conventional printing system. With reference to FIG. 1, when a document is to be printed through the printer, a user sets the print conditions (for example, print sheets, print range, the number of print sheets, and print mode) using a screen for setting the print condition information provided from the printer driver. After setting the print conditions, when the print command is input at step S100, the printer driver translates the print data into a data format that can be interpreted by the printer at step S110, allows the data format to be stored in a print spooler at step S120, and outputs the print data to the port of the printer via a language monitor or directly at step S130.

Depending on the print data format and the data which is output to the port and sent from the printer, the error status of the printing system is determined at step S140. When it is determined that there is no error, the printer performs a normal print operation. When it is determined that there are errors at step S140, the printer driver indicates via a display window the error message that the error(s) has occurred at step S160, with the error message causing a user to either retry or cancel the print. In response to the error message, the user selects any one of the retry or the cancellation at step S170. When the print retry is selected, the steps S130 to S170 are repeated, whereas when the print cancellation is selected, the print operation is ended.

However, if the user does not have sufficient experience with the information on the computer and the printer, it is difficult for the user to solve the problem since the print error message is simply indicated. Consequently, the printer manufacturer bears the unnecessary service expense since the service is required for the simple error in the printing system.

### SUMMARY OF THE INVENTION

The present general inventive concept has been developed in order to solve the above drawbacks and other problems associated with the conventional arrangement. Accordingly, it is an aspect of the present general inventive concept to provide an apparatus and a method of self-diagnosing errors in a printing system that can afford convenience to a user and reduce service costs by self-diagnosing the print errors resulting from a host and correcting the host errors for itself.

Additional aspects and advantages of the present general inventive concept will be set forth in part in the description which follows and, in part, will be obvious from the description, or may be learned by practice of the general inventive concept.

In order to accomplish the foregoing and other aspects and advantages of the present general inventive concept. There is provided an apparatus having error self-diagnostics of a printing system and including a printer that receives print data and printing images corresponding to the print data on sheet, and a host that translates documents created by an application program into the print data through a driver of the printer, accumulates the translated print data in a print spooler and sends the accumulated print data to the printer, the apparatus including an error database (DB) that stores a print error list that can occur from the host and corresponding cause list, an error sensor that senses the print error occurrence, and a self-diagnostics part that detects the error cause list corresponding to the sensed print error from the error DB to correct the print error.

In an aspect of the present general inventive concept, the print error may include at least one of the error in the printer driver that can be sensed while the document is being translated into the print data and the error in the print spooler that can be sensed while the print data is being accumulated in the print spooler.

In another aspect of the present general inventive concept, the apparatus having error self-diagnostics may further include an error correction decision part that determines whether the print error has been corrected when the self-diagnostics part has completed the error correction process based on the error cause list, and a guide wizard performance part that provides a guide screen displaying the detected cause of the error and the error correction approach to take in order for the user to manually solve the sensed print error when it is determined that the error correction process has failed.

The foregoing and/or other aspects and advantages of the present general inventive concept can also be achieved by providing a method having error self-diagnostics of a printing system and including a printer that receives print data and printing images corresponding to the print data on a sheet, and a host that translates a document created by an application program into the print data through a driver of the printer, accumulates the translated print data in a print spooler and sends the accumulated print data to the printer, the method including preparing an error database (DB) that stores a print error list that can occur from the host and a corresponding cause list, sensing the print error occurrence, and detecting and self-diagnosing the error cause list corresponding to the sensed print error from the error DB to correct the print error.

In an aspect of the present general inventive concept, the print error includes at least one of the error in the printer driver that can be sensed while the document is being translated into the print data and the error in the print spooler that can be sensed while the print data is being accumulated in the print spooler.

In another aspect of the present general inventive concept, the method may further include determining whether the print error has been corrected when the self-diagnostics part has completed the error correction based on the error cause list, and performing a guide wizard operation that provides a guide screen displaying the detected cause of the error and the error correction approach to take in order for the user to manually solve the sensed print error when it is determined that the error correction process has failed.

The foregoing and/or other aspects of the present general inventive concept can also be achieved by providing an apparatus having error self-diagnostics for a host of a printer that translates a document created by an application program into print data through a driver of the printer, accumulates the translated print data in a print spooler and sends the accumulated print data to the printer, the apparatus including an error DB that stores a print error list that can occur from the host and corresponding cause list, an error sensor that senses the print error occurrence, and a self-diagnostics part that detects the error cause list corresponding to the sensed print error from the error DB to correct the print error.

In another aspect of the present general inventive concept, the print error includes at least one of the error in the printer driver that can be sensed while the document is being translated into the print data and the error in the print spooler that can be sensed while the print data is being accumulated in the print spooler.

In another aspect of the present general inventive concept, the apparatus having error self-diagnostics may further include, when the self-diagnostics part has completed the error correction based on the error cause list, an error correction decision part that determines whether the print error has been corrected, and a guide wizard performance part that provides a guide screen displaying the detected cause of the error and the error correction approach to take in order for the user to manually solve the sensed print error when it is determined that the error correction has failed.

The foregoing and/or other aspects and advantages of the present general inventive concept may also be achieved by providing a method having error self-diagnostics of a host of a printer that translates a document created by an application program into print data through a driver of the printer, accumulates the translated print data in a print spooler and sends the accumulated print data to the printer, the method including preparing an error DB that stores a print error list of errors that can occur from the host and a corresponding cause list, sensing the print error occurrence, and detecting and self-diagnosing the error cause list corresponding to the sensed print error from the error DB to correct the print error.

In an aspect of the present general inventive concept, the print error may include at least one of the error in the printer driver that can be sensed while the document is being translated into the print data and the error in the print spooler that can be sensed while the print data is being accumulated in the print spooler.

In another aspect of the present general inventive concept, the method may further include determining whether the print error has been corrected, when the self-diagnostics part has completed the error correction process based on the error cause list, and performing a guide wizard that provides a guide screen displaying the detected cause of the error and the error correction approach to take in order for the user to manually solve the sensed print error when it is determined that the error correction process has failed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating an example of the operation method of a conventional printing system;

FIG. 2 is a block diagram illustrating the printing system to which an apparatus having error self-diagnostics is applied according to an embodiment of the present general inventive concept;

FIG. 3 is a view illustrating an example of an error DB according to an embodiment of the present general inventive concept;

FIG. 4 is a flowchart illustrating operations of the apparatus having error self-diagnostics according to an embodiment of the present general inventive concept.

FIG. 5 is a detailed flowchart illustrating exemplary operations of self-diagnosing an error in the printer driver in FIG. 4; and

FIG. 6 is a detailed flowchart illustrating exemplary operations of self-diagnosing an error in the print spooler in FIG. 4.

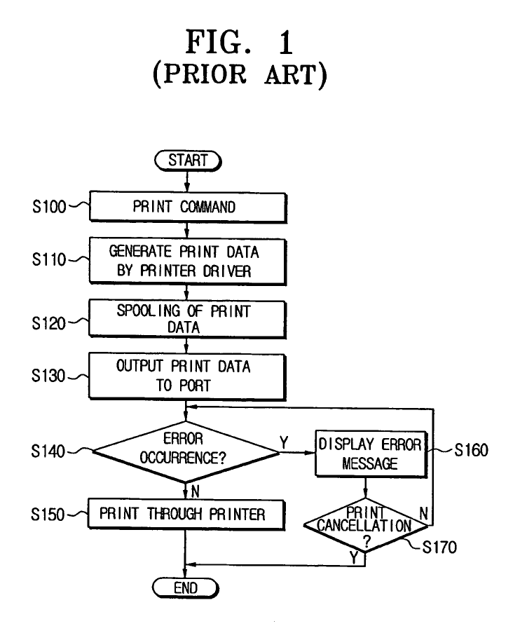

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

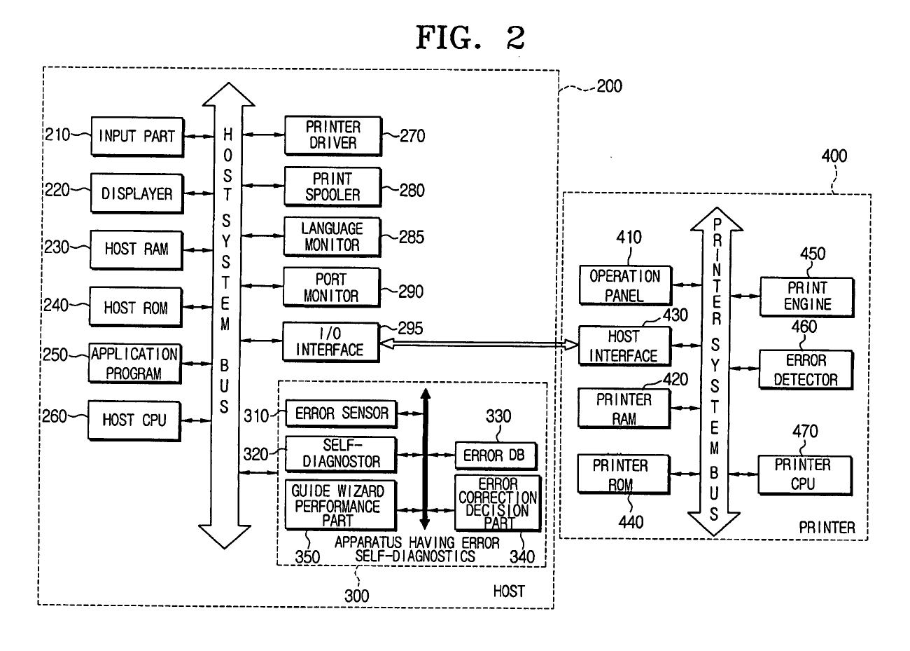

FIG. 2 is a block diagram of a printing system to which an apparatus having error self-diagnostics is applied according to an embodiment of the present general inventive concept. With reference to FIG. 2, the printing system includes a host 200, an apparatus having error self-diagnostics 300 incorporated in the host 200, and a printer 400.

The host 200 translates a document prepared by an application program into print data that can be interpreted by the printer 400, and sends the print data to the printer 400. The apparatus having error self-diagnostics 300 can sense a print error occurring from the host and corrects the error through the self-diagnostics. The printer 400 prints images corresponding to the print data sent from the host 200 on sheets in communication with the host 200.

The host 200 can include an input part 210, a displayer 220, a host random access memory (RAM) 230, a host read only memory (ROM) 240, an application program 250, a host central processing part (CPU) 260, a printer driver 270, a print spooler 280, a language monitor 285, a port monitor 290, an input/output (I/O) interface 295, and the apparatus having error self-diagnostics 300.

The input part 210 can receive a key input signal according to a key operation of a user and sends the input signal to the host CPU 260 described below. As the input part 210, a keyboard, a mouse, and a touch panel can be applied, or any other input unit that provides the operations intended by input unit described in the present general inventive concept.

The displayer 220, which can be a general monitor, displays the operation status of the host 200 according to the control of the host CPU 260. According to an embodiment of the present general inventive concept, a guide wizard screen provided to the user can be displayed on the displayer 220 in order to correct the print error and to print the error, which is described below.

The host ROM 240, which is a non-volatile memory element, stores various control programs necessary to implement the functions of the host 200. The host RAM 230, which is a volatile memory element, temporarily stores data according to the execution of various control programs executed in the host CPU 260.

The application program 250 may include various document edit programs that can create documents, and may, for example, include Office programs developed by Microsoft Corporation.

The printer driver 270 translates documents created by the document edit program into print data that can be interpreted by the printer 400.

The print spooler 280 is a kind of program provided by the operating system, and is a program that manages the spooling of the print data output from the printer driver 270. The print data that is temporarily stored in the print spooler 280 is sent to the port monitor 290 based on the processing speed of the printer 400.

The language monitor 285 provides the status of the print spooler 280 and the status of the printer 400, such as a printer error received via the port monitor 290, to the printer driver 270, in cooperation with the print spooler 280 and the port monitor 290.

The port monitor 290 is a program that controls the I/O interface 295 that is electrically and physically connected to the printer 400, and allows the print data provided from the print spooler 280 to be sent to the printer 400 via the I/O interface 295.

The I/O interface 295 provides an interface for smooth data communications with the printer 400.

The apparatus having error self-diagnostics 300 can be incorporated into the host 200, and self-diagnoses the print error occurring from the host per se to automatically cure the error. Also, the apparatus having error self-diagnostics 300 can be incorporated into the printer driver 270 and can include an error sensor 310, a self-diagnostor 320, an error DB 330, an error correction decision part 340, and a guide wizard performance part 350.

The error sensor 310 senses an error occurring while the printer driver 270 is generating the print data and an error occurring during the spooling of the print data onto the print spooler 280. The error occurring upon generating the print data can be sensed by an error message generated by the printer driver 270, and the error in the print spooler 280 can be sensed by the error message occurring from the operating system of the host 200 or by checking the status of the print spooler 280.

The self-diagnostor 320 corrects errors based on causes of errors corresponding to the sensed print error, and reads out the cause of the error corresponding to the sensed error from the error DB storing the list of errors that can occur from the printing system, and especially from the host 200, and also the corresponding cause of error list, and corrects the error based on an error correction process using the cause of the error list.

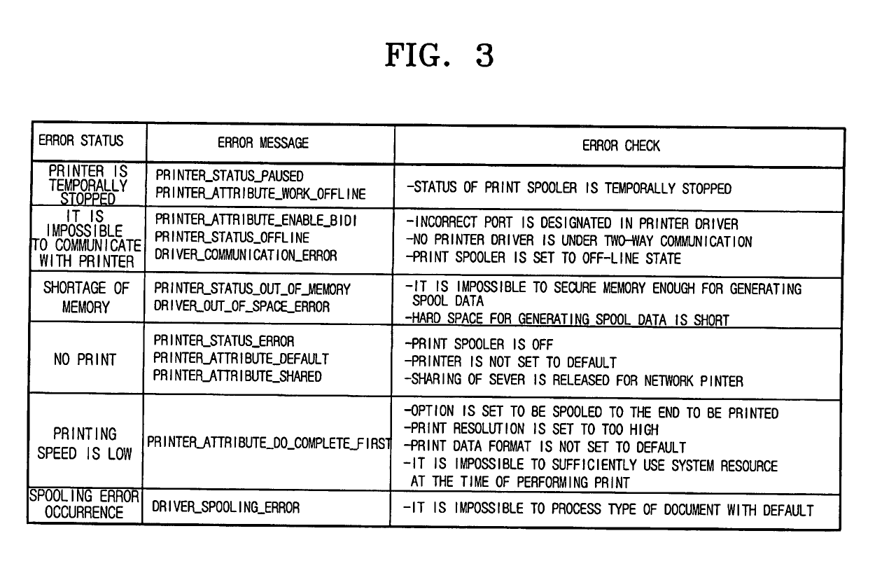

FIG. 3 is a view illustrating an example of the error DB 330 according to an embodiment of the present general inventive concept. With reference to FIG. 3, error status such as “PRINTER IS TEMPORARILY STOPPED,” and “IT IS IMPOSSIBLE TO COMMUNICATE WITH PRINTER,” corresponds to a case in which the error has occurred and is sensed while the printer driver 270 is processing data. Error status such as “SHORTAGE OF MEMORY,” “NO PRINT,” “PRINTING SPEED IS LOW,” and “SPOOLING ERROR OCCURANCE,” corresponds to a case in which the error has occurred and is sensed while the print spooler 280 is processing data.

For instance, if an error such as “PRINTER_ATTRIBUTE_DO_COMPLETE_FIRST” is sensed from the operating system providing the print spooler 280, the error sensor 310 senses the error message from the operating system. In response to the sensed error, the self-diagnostor 320 reads out “OPTION IS SET TO BE SPOOLED TO THE END TO BE PRINTED,” “PRINT RESOLUTION IS SET TOO HIGH,” “PRINT DATA FORMAT IS NOT SET TO DEFAULT,” and “IT IS IMPOSSIBLE TO SUFFICIENTLY USE SYSTEM RESOURCE AT THE TIME OF PERFORMING PRINT,” which are causes of the error corresponding to the sensed error “PRINTER_ATTRIBUTE_DO_COMPLETE_FIRST,” from the error DB 330.

In accordance with the read out causes of the error, the self-diagnostor 320 checks in sequence whether the print spooler 280 is currently set, and performs the error correction according to the corresponding cause of the print error. For example, it is checked whether the cause of the error is the first cause being “OPTION IS SET TO BE SPOOLED TO THE END TO BE PRINTED.” When it is correctly set, i.e., the cause of the error is not the first cause, it is checked whether the next cause is “PRINT RESOLUTION IS SET TOO HIGH”. When the print resolution is set to a value greater than a prescribed threshold, the self-diagnostor 320 controls the printer driver 270 to allow the print resolution to be set to a value lower than the prescribed threshold. If there is no problem in the print resolution, the self-diagnostor 320 attempts to solve the problem based on the next cause.

When the self-diagnostic process is completed in the self-diagnostor 320, the error correction decision part 340 determines whether the error has been corrected. If the error has not been corrected, although the self-diagnostor 320 has performed the sequence of checks on all of the causes of errors, it is determined that the error correction process has failed.

When it is determined by the error correction decision part 340 that the error correction process has failed, the guide wizard performance part 350 provides a guide screen allowing the user to manually correct the error via the displayer 220. The guide screen provides causes that can result in the error based on the error DB 330, and proposes a user's solution based on the provided causes.

The printer 400 may include an operation panel 410, a host interface 430, a printer RAM 420, a printer ROM 440, a print engine 450, an error detector 460, and a printer CPU 470. The operation panel 410 may include a plurality of operation keys that can select and set functions supported by the printer 400 and a given display panel (not shown), applies a key input signal corresponding to the key operation to the printer CPU 470, and displays the operating status of the printer 400 on the display panel (not shown) according to the control of the printer CPU 470.

The printer ROM 440, which is a non-volatile memory element, stores various control programs necessary to implement the functions supported by the printer 400. The printer RAM 420, which is a volatile memory element, stores temporary data according to the result of program performance of the printer CPU 470 and various data that has occurred in the process of the received print data.

The host interface 430 provides an interface for smooth data communications with the host 200.

The print engine 450 performs the print operation that print-processes the print data on the recording sheets according to the control of the printer CPU 470.

The error detector 460 monitors the operation status of the host interface 430 and the print engine 450 and detects whether or not the error has occurred in the printer 400 during the process of receiving the print data transmitted from the host 200 or during the process of performing the print operation of the print data. When the error has occurred in the printer 400, the error detector 460 detects the type of the error that has occurred and sends an error message corresponding to the detected error to the printer CPU 470.

The printer CPU 470 controls each part of the printer 400 to allow the printer 400 to smoothly perform the print operations, and sends the error message, such as a paper jam and a shortage of sheet detected, from the error detector 460 to the host 200.

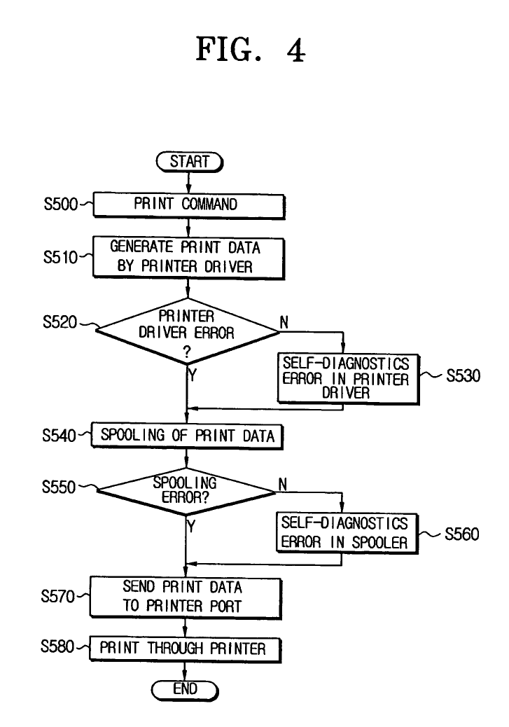

FIG. 4 is a flowchart illustrating operations of the apparatus having error self-diagnostics according to an embodiment of the present general inventive concept. With reference to FIG. 4, when a document is to be printed by the printer 400, the user sets the print conditions (such as print sheet, print range, the number of print sheets, and print mode) using a print condition information setting screen that is provided by the printer driver 270. After setting the print conditions, when the print command is input at operation S500, the printer driver 270 translates the print data into a data format that can be interpreted by the printer 400 at operation S510. After completing the translation of the print data by the printer driver 270, the error sensor 310 checks if an error has occurred in the printer driver 270 at operation S520.

When it is determined that an error has occurred in the printer driver 270, the self-diagnostor 320 performs the error correction operation by detecting the cause of the error corresponding to the error that has occurred from the error DB 330 and removing the cause of the error.

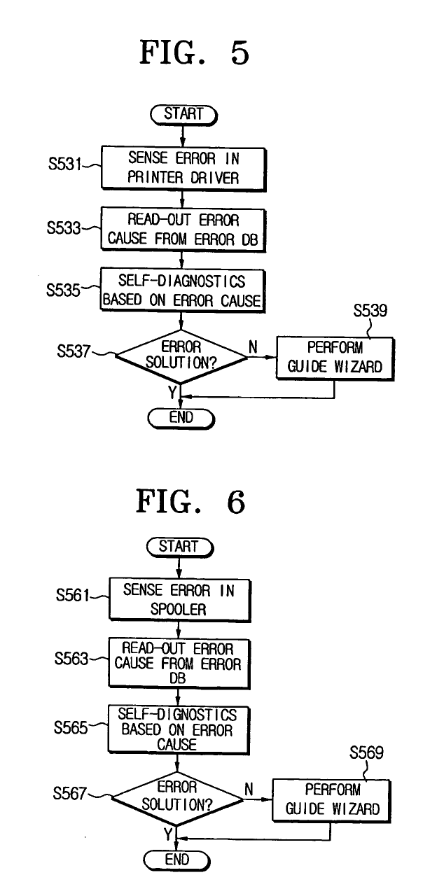

FIG. 5 is a detailed flowchart illustrating operations of self-diagnosing an error in the printer driver in FIG. 4. With reference to FIG. 5, after completing the translation of the print data by the printer driver 270, when an error is sensed at operation S531, the self-diagnostor 320 reads-out the cause of error list corresponding to the sensed error from the errors in the printer driver 270, from the error DB 330 at operation S535, and performs the self-diagnostics operation according to the cause of the error at operation S535. When the self-diagnostic performance on the error is completed, the error correction decision part 340 checks if the error has been corrected at operation S537. As a result, when it is determined that the error has been corrected, the self-diagnostic performance on the error is ended. When it is determined that the error correction has failed, the guide wizard is performed to provide a guide screen in which the user can manually correct the error at operation S539.

In the operation S530, when it is determined that the error correction has been completed or that there is no error in the printer driver 270, the translated print data is spooled onto the print spooler 280 at operation S540. It is then checked whether the error has occurred in the process of spooling in the print spooler 280 at operation S550.

In operation S550, when it is sensed that the error has occurred in the print spooler 280, the self-diagnostics operation on the error in the print spooler 280 is carried out at operation S560. FIG. 6 is a detailed flowchart illustrating operations of self-diagnosing the error in the print spooler in FIG. 4. The error sensor 310 senses whether the error in the print spooler 280 has occurred from the operating system and senses the error in the print spooler 280 at operation S561. In response to the sensed error in the print spooler 280, the self-diagnostor 320 reads-out the error cause list corresponding to the sensed error out of the errors in the printer spooler 280 from the error DB 330, at operation S563, and performs the error self-diagnostics operation to connect the error according to the read-out error cause, at operation S565. The error correction decision part 340 checks whether the error has been corrected at operation S567. When it is determined that the error correction has failed, the guide wizard is performed at operation S569 to provide the guide screen in which the error in the print spooler 280 can be corrected.

Subsequently, the print data having the error corrected is sent to the printer port at operation S570, and the printer 400 performs a predetermined image processing on the received print data and prints the image-processed data on the sheet.

With the method described above, it is possible to automatically correct the error in the host 200, and when the error correction by the self-diagnostics fails, it is possible for the user to conveniently use the printing system without the pre-knowledge on the host 200 and the printer 400 since it is provided with the guide wizard.

As explained above, in accordance with embodiments of the present invention, the self-diagnostics operation is performed on the print error occurring from the host, the error is automatically is corrected, and then the corrected error is sent to the printer. Also, even if the self-diagnostics operation on the print error fails, it is possible for the user to easily find the print error without the pre-knowledge on the computer and the printer since it is provided with a guide wizard for error correction. Thus, it is possible to reduce the service costs of the printer manufacturer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus having error self-diagnostics of a printing system that includes a printer that receives print data and prints images corresponding to the print data on a sheet, and a host that translates a document created by an application program into the print data through a driver of the printer, accumulates the translated print data in a print spooler and sends the accumulated print data to the printer, the apparatus comprising:
an error database (DB) that stores a list of print errors that can occur from the host and a corresponding cause of error list;
an error sensor that senses a print error occurrence; and
a self-diagnostor that detects the cause of error list corresponding to the sensed print error from the error DB and corrects the print error based on an error correction process using the cause of error list.

2. The apparatus as claimed in claim 1, wherein the print error includes at least one of an error in the printer driver that can be sensed while the document is being translated into the print data and an error in the print spooler that can be sensed while the print data is being accumulated in the print spooler.

3. The apparatus as claimed in claim 1, further comprising:
an error correction decision part that determines whether the print error has been corrected when the self-diagnostor has completed the error correction process based on the cause of error list; and
a guide wizard performance part that provides a guide screen displaying the detected cause of the print error and an error correction approach to take in order for the user to manually solve the sensed print error when it is determined that the error correction process has failed.

4. The apparatus as claimed in claim 1, wherein the apparatus having error self-diagnostor is incorporated into the host.

5. The apparatus as claimed in claim 1, wherein the apparatus having error self-diagnostor is incorporated into the printer driver.

6. The apparatus as claimed in claim 1, wherein the host includes an input/output interface to provide smooth data communications with the printer.

7. The apparatus as claimed in claim 2, wherein when the print error has occurred and is sensed while the printer driver is processing data, the print error list to be read out from the DB includes “PRINTER IS TEMPORARILY STOPPED” and “IT IS IMPOSSIBLE TO COMMUNICATE WITH PRINTER.”

8. The apparatus as claimed in claim 2, wherein when an error has occurred and is sensed while the print spooler is processing data, the print error list to be read out from the DB includes “SHORTAGE OF MEMORY,” “NO PRINT,” “PRINTING SPEED IS LOW,” and “SPOOLING ERROR OCCURANCE.”

9. A method having error self-diagnostics of a printing system that includes a printer that receives print data and prints images corresponding to the print data on a sheet, and a host that translates a document created by an application program into the print data through a driver of the printer, accumulates the translated print data in a print spooler and sends the accumulated print data to the printer, the method comprising:
preparing an error database (DB) that stores a list of print errors that can occur from the host and a corresponding cause of error list;
sensing the print error occurrence; and
detecting the cause of error list and self-diagnosing the cause of the print error based on an error correction process using the cause of error list.

10. The method as claimed in claim 9, wherein the print error includes at least one of an error in the printer driver that can be sensed while the document is being translated into the print data and an error in the print spooler that can be sensed while the print data is being accumulated in the print spooler.

11. The method as claimed in claim 9, further comprising:
determining whether the print error has been corrected when the self-diagnostics operation has completed the error correction process based on the cause of error list; and
performing a guide wizard operation that provides a guide screen displaying the detected cause of error and the error correction approach to take in order for the user to manually solve the sensed print error when it is determined that the error correction process has failed.

12. An apparatus having error self-diagnostics of a host unit of a printer that translates a document created by an application program into print data through a driver of the printer, accumulates the translated print data in a print spooler and sends the accumulated print data to the printer, comprising:
an error database (DB) that stores a list of print errors that can occur from the host and a corresponding cause of error list;
an error sensor that senses a print error occurrence; and
a self-diagnostor that detects the cause of error list corresponding to the sensed print error from the error DB and corrects the print error based on an error correction process using the cause of error list.

13. The apparatus as claimed in claim 12, wherein the print error includes at least one of an error in the printer driver that can be sensed while the document is being translated into the print data and an error in the print spooler that can be sensed while the print data is accumulated in the print spooler.

14. The apparatus as claimed in claim 12, further comprising:
an error correction decision part that determines whether the print error has been corrected when the self-diagnostor has completed the error correction process based on the cause of error list; and
a guide wizard performance part that provides a guide screen displaying the detected cause of error and the error correction approach to take in order for the user to manually solve the sensed print error when it is determined that the error correction process has failed.

15. The apparatus as claimed in claim 12, wherein the apparatus having error self-diagnostics is incorporated into the host.

16. The apparatus as claimed in claim 12, wherein the apparatus having error self-diagnostics is incorporated into the printer driver.

17. A method having error self-diagnostics of a host of a printer that translates a document created by an application program into print data through a driver of the printer, accumulates the translated print data in a print spooler and sends the accumulated print data to the printer, the method comprising:
preparing an error database (DB) that stores a list of print errors that can occur from the host and a corresponding cause of error list;
sensing a print error occurrence; and
detecting the cause of error list and self-diagnosing the cause of the print error based on an error correction process using the cause of error list.

18. The method as claimed in claim 17, wherein the print error includes at least one of an error in the printer driver that can be sensed while the document is being translated into the print data and an error in the print spooler that can be sensed while the print data is being accumulated in the print spooler.

19. The method as claimed in claim 17, further comprising:
determining whether the print error has been corrected when the self-diagnostor has completed the error correction process based on the cause of error list; and
performing a guide wizard that provides a guide screen displaying the detected cause of the error and the error correction approach to take in order for the user to manually solve the sensed print error when it is determined that the error correction process has failed.

20. A self-diagnostics apparatus used with a printer that receives print data and prints images corresponding to the print data by using a host member in the printer to translate a document created by an application program into the print data through a printer driver, accumulates the translated print data in a print spooler and sends the accumulated print data to the printer, the self-diagnostics apparatus comprising:
an error sensor that senses an error occurring during at least one of the operations of generation of print data by the printer driver or spooling or the print data onto the spooler; and
a diagnosis unit that reviews a pre-stored cause of error list corresponding to the sensed error and corrects the error based on an error correction process using the pre-stored cause of error list.

21. The apparatus as claimed in claim 20, further comprising an error database (DB) that stores the list of errors that can occur during the host operations and the corresponding cause of error list.

22. The apparatus as claimed in claim 21, wherein the print error includes at least one of an error in the printer driver that can be sensed while the document is being translated into the print data and an error in the print spooler that can be sensed while the print data is being accumulated in the print spooler.

23. The apparatus as claimed in claim 22, further comprising:
an error correction decision part that determines whether the print error has been corrected when the diagnosis unit has completed the error correction process based on the cause of error list; and
a guide wizard performance part that provides a guide screen displaying the detected cause of the print error and an error correction approach to take in order for a user to manually solve the sensed print error when it is determined that the error correction process has failed.
